(19) United States
(12) Patent Application Publication
(10) Pub. No.: US 2026/0178541 A1
(43) Pub. Date: Jun. 25, 2026

(54) SYSTEM AND METHOD FOR QUERYING METHODS

(71) Applicant: Aivres Systems Inc., San Jose, CA (US)

(72) Inventor: Yenmin CHENG, New Taipei City (TW)

(21) Appl. No.: 18/991,030

(22) Filed: Dec. 20, 2024

(51) Int. Cl. G06F 16/14

(52) U.S. Cl. CPC G06F 16/148; G06F 16/156

(57) ABSTRACT

A method for querying methods is provided. A connection is established with a system. An object path is specified for the system where the object path identifies a plurality of method callers associated with the system. A file path is specified for the system, where the file path identifies a configuration file that includes a plurality of methods associated with the system. A command associated with the system is received, where the command invokes a method caller of the plurality of method callers, and a subset of the plurality of methods associated with the system are displayed, based on the received query.

### FIELD

The present disclosure relates to querying methods.

### BACKGROUND

Message-oriented middleware, such as Desktop Bus (“D-Bus”) are widely used for inter-process communication (IPC) and facilitate communication between different applications within a computer system. It supports the transmission of complex messages, including method calls, signals, and property changes. However, current services are limited in scope, typically offering only a static set of methods. A significant limitation is the inability to dynamically query or display method definitions and parameter information while the service is running. Instead, these details are often manually documented, a process that is both inefficient and error-prone, making it difficult to perform dynamic queries.

Existing tools, such as D-Feet and busctl, offer some functionality for querying the interface and its methods. However, they fall short in providing a dynamic display of detailed parameter information or comprehensive descriptions of methods. Furthermore, they do not support specific queries based on object paths or method names.

### SUMMARY

A first aspect of the present disclosure provides a method for querying methods. The method includes establishing a connection with a system, specifying an object path for the system, wherein the object path identifies a plurality of method callers associated with the system, specifying a file path for the system, wherein the file path identifies a configuration file that includes a plurality of methods associated with the system, receiving a command associated with the system, invoking a method caller of the plurality of method callers, and displaying a subset of the plurality of methods associated with the system, based on the received query.

A second aspect of the present disclosure provides a system for querying methods. The system includes a controller. The controller is configured to establish a connection with a system, specify an object path for the system, wherein the object path identifies a plurality of method callers associated with the system, specify a file path for the system, wherein the file path identifies a configuration file that includes a plurality of methods associated with the system, receive a command associated with the system, invoking a method caller of the plurality of method callers, and display a subset of the plurality of methods associated with the system, based on the received query.

A third aspect of the present disclosure provides a tangible, non-transitory computer-readable medium for querying methods, the computer-readable medium having instructions thereon, which, upon being executed by one or more processors, provides for execution of the following steps: establishing a connection with a system; specifying an object path for the system, wherein the object path identifies a plurality of method callers associated with the system; specifying a file path for the system, wherein the file path identifies a configuration file that includes a plurality of methods associated with the system; receiving a command associated with the system, invoking a method caller of the plurality of method callers; and displaying a subset of the plurality of methods associated with the system, based on the received query.

### BRIEF DESCRIPTION OF THE DRAWINGS

Systems and methods for querying methods are described in detail below with reference to the attached drawing figures, wherein:

FIG. 1 illustrates a block diagram of a system, according to one or more embodiments of the present disclosure.

FIG. 2 illustrates a block diagram illustrating a system, according to one or more embodiments of the present disclosure.

FIG. 3 illustrates a method for implementing aspects according to the present disclosure, according to one or more embodiments.

FIG. 4 illustrates a method for implementing aspects of the present disclosure, according to one or more embodiments.

### DETAILED DESCRIPTION

The following detailed description is merely exemplary in nature and is not intended to limit the disclosure or the application and uses of disclosed embodiments and methods. Furthermore, there is no intention to be bound by any expressed or implied theory presented in the preceding background, summary, brief description of the drawings or the description that follows.

Embodiments of the present disclosure provide a system and method for dynamically querying and displaying methods and parameter information. By way of example, the system contains a service, e.g., a D-Bus service, that can read method and parameter definitions and description information from configuration files, and provide a variety of query methods, including displaying all methods and their parameters, querying methods by object path, and method names.

In some embodiments, the system and method dynamically query and display methods, e.g., D-Bus methods, and allow for flexible and real-time acquisition of system information. In some additional embodiments, the present disclosure provides detailed information display by using a configuration file to record parameter types and descriptions. This enables comprehensive parameter details and explanations to be shown during queries, enhancing user understanding.

Additionally, according to embodiments of the present disclosure the process of dynamically querying methods, such as D-Bus methods, may be expanded due to the clear structure of the configuration file, which allows new interfaces and methods to be added seamlessly. In certain embodiments, the dynamic query process described herein promotes efficient management by reducing the manual effort required to record and query method parameters, improving both the accuracy and efficiency of system management.

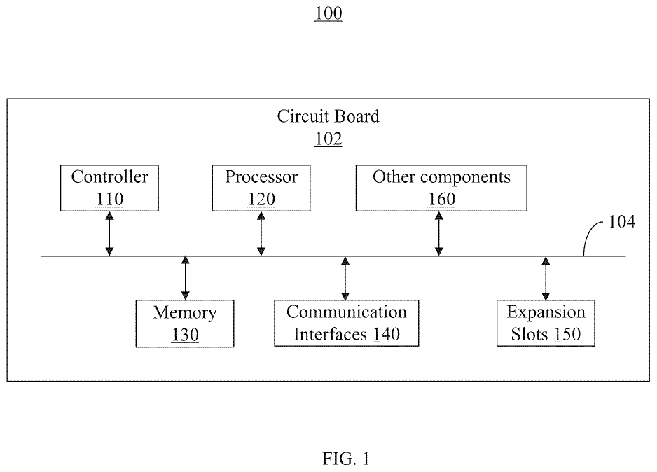

FIG. 1 illustrates a block diagram of a system 100, e.g., server, suitable for use in implementing embodiments of the present disclosure. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed components or devices, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the server system 100 falls within the scope and intent of the disclosed embodiments. The server system 100 can be housed in a rack-mounted chassis designed for optimal airflow and cooling, ensuring efficient heat dissipation during operation. Yet further, a person skilled in the art will recognize that the systems and methods described herein can be used with computer systems other than server systems.

The system 100 typically includes one or more circuit boards, e.g., a motherboard 102, that may carry various components, including hardware, firmware, and/or software, which may be integrated with, attached to, connected to, or in communication with the motherboard. As shown in FIG. 1, the motherboard 102 carries at least one controller 110, such as a baseboard controller (BMC), one or more processors 120, memory 130, communication interfaces 140, one or more expansion slots 150, and one or more other components 160. Such components and the circuit board 102 can communicate with one another through a bus 104 (e.g., integrated into the circuit board 102).

Processor(s) 120 may be configured to perform the operations in accordance with the instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor (e.g., a central processing unit (CPU) or graphics processing unit (GPU), respectively), digital signal processor, microcontroller, or the like. Memory 130 may be configured to store computer-readable instructions that, when executed by processor(s) 130, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), EEPROM, a flash memory, a dynamic random-access memory (“RAM”), and/or a static RAM. In certain embodiments, memory 130 may include multiple storage devices of various types.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10G Ethernet adaptor, or the like. Wireless links can also be implemented by communication interfaces 140. In such an implementation, communication interfaces 140 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

Controller 110, e.g., BMC, may include a processing unit, internal memory, and communication interfaces, and is configured to monitor and manage the system's hardware components among other things. Controller 110 handles tasks such as remote system management, including hardware health monitoring, system event logging, fault diagnosis and power control. Controller 110 can operate independently of the system's 100 main processor (e.g., processor(s) 120), allowing for out-of-band management. Controller 110 may in certain embodiments facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, and more.

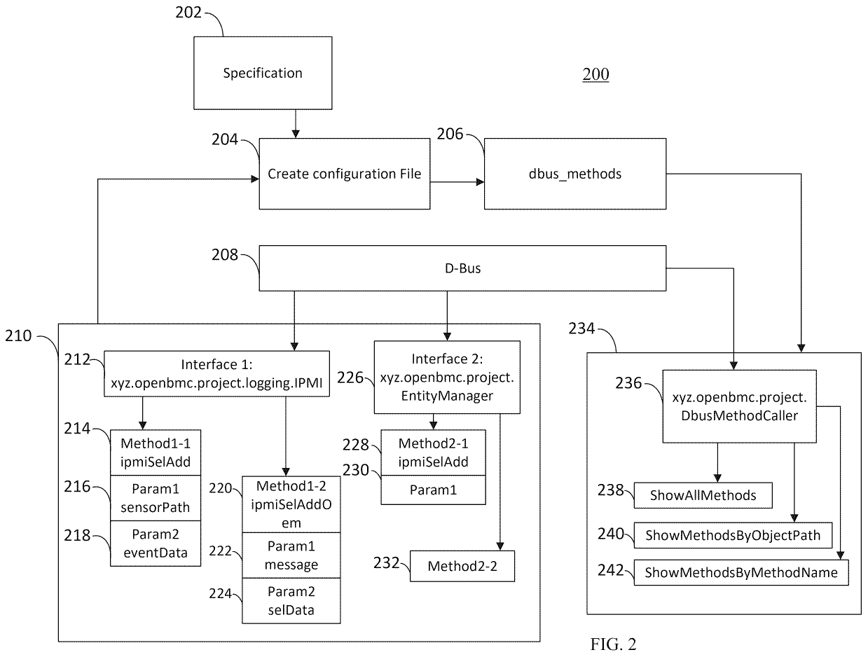

FIG. 2 illustrates a block diagram of a system, in accordance with one or more embodiments of the present disclosure. The system, which by way of example is a D-Bus system 200, implements a service-based communication model that facilitates seamless interaction between applications, system components, and services. Within this system, the connected applications, components, or services are represented as objects. These objects serve as the endpoints for communication on, for example, a D-Bus.

Each object plays a role in facilitating functionality and may be protected from direct access to prevent tampering or unintended interactions. Access to an object's features and data is mediated through an interface. An interface is a logical grouping that organizes the object's exposed functionality into methods, signals, and properties. For example, an interface might allow an application to call specific methods on an object, listen for emitted signals, or retrieve and modify properties.

To uniquely identify each object, an object path is used. This object path acts as an address, allowing other applications to locate and interact with the object. Through the interface, methods can be invoked to perform specific actions, such as initiating a task or retrieving data. Methods represent the callable functions that an object offers. Signals, on the other hand, allow objects to broadcast events to notify other applications of changes or occurrences. Properties provide a way to access or modify the state of the object.

Currently, tools such as D-Feet and busctl are commonly used to interact with D-Bus objects and their interfaces. However, they are limited in their capabilities. They do not dynamically display detailed parameter information or provide comprehensive descriptions of methods. Additionally, they lack the ability to perform specific queries based on object paths or method names, making them insufficient for more advanced or dynamic use cases.

The system, e.g., D-Bus system 200, as described in the present disclosure, provides an improved framework for interacting with objects, interfaces, and methods in a more dynamic and accessible manner. This allows for more efficient communication between system components and better usability for developers and applications. It will be understood that the particular interfaces, methods and the like described in connection with FIG. 2 are provided as examples to illustrate the methods and systems of the present disclosure and are not intended to limit the methods and systems described herein.

The D-Bus system 200, as shown in FIG. 2 includes a D-Bus 208 that is connected to each interface within a plurality of interfaces 210. In some embodiments, each interface of the plurality of interfaces 210 may define a set of methods that may be used to interface with a corresponding object. The definition of each interface of the set of interfaces may include a path that provides a location of a corresponding object that the interface is configured to expose.

For example, the interface 212 of the plurality of interfaces 210 may include a path, e.g., “xyz.openbmc.project.logging.IPMI,” that may be used to access the methods that provide functionalities of Intelligent Platform Management Interface (IPMI) for out-of-band management of computer systems. The interface 212 may include a first method 214 and a second method 220 to interact with IPMI. The first method 212 may be named ipmiSelAdd and may be configured to add a new event to a system event log (SEL). The first method 214 is usually invoked with two parameters. In some embodiments, the first method 214 may use parameters that specify the details of an event to be logged. Examples of parameters used with the first method 214 include a sensorPath parameter 216 and an eventData parameter 218. In some embodiments, the sensorPath parameter 216 may include an identifier for a hardware sensor or component related to the event. The eventData parameter 218 may include additional data describing the event, such as an error code, a status change, or contextual information. These parameters are, of course, provided by way of example and not limitation.

As another example, the second method 220 of interface 212 may be named ipmiSelAddOem and may be used to extend the functionality of ipmiSelAdd to handle OEM-specific events in the SEL. The second method 220 of interface 212 may be invoked with various parameters. Examples of parameters used with the second method 220 include a message parameter 222 and a selData parameter 224.

Additionally, interface 226 of the plurality of interfaces 210 may include an address “xyz.openbmc.project.logging.EntityManager” that may be used for logging and entity management. The interface 226 may include a first method 228 and a second method 232. The first method 228 may be invoked using a parameter and the second method 232 may be invoked without any parameters.

The information provided in the plurality of interfaces 210 may be used to create a configuration file 206 at 204. By way of example, the configuration file 206 may be called dbus_methods and may include information related to each method included in the plurality of interfaces 210. For example, the configuration file 206 may include an entry corresponding to each method in the plurality of interfaces 210. In some cases, the entry may include a name of the method, parameters used to invoke the method, and a brief description of the action performed by the method. In some embodiments, the configuration file 206 may be a Javascript Object Notification (JSON) file.

In some embodiments, the configuration file 206 may be created using a specification 202 provided by a user. In such cases, the configuration file may be edited at any time to add or delete entries related to methods utilized in the plurality of interfaces 210.

In order to access method information stored in the configuration file 206, a new D-Bus connection may be established with a new object 234. A path for a new object may used to identify the interface 236. For example, a path of the new object may be identified as “xyz.openbmc.project.Dbusmethodcaller.” New methods may be defined in the interface 236. For example, the three methods may include a ShowAllMethods 238, a ShowMethodsByObjectPath 240, and a ShowMethodsByName 242. The methods defined in the interface 236 may be configured to access the configuration file 206 and provide the methods listed in the configuration file 206 as an output. In some embodiments, the different methods of the interface 236 may be configured to search for different methods in the configuration file 206 based on parameters provided. In accordance with embodiments of the present disclosure, in order to access the configuration file 206, a path of the configuration file 206 is provided to the interface 236 so that the methods 238, 240, and 242 may access the configuration file 206.

In some embodiments, the method ShowAllMethods 238 opens the configuration file 206, parses it into an object, and then traverses the object to extract interface names, method names, and parameters, returning this information in a formatted string. If the configuration file 206 cannot be opened, a runtime error is thrown.

The method ShowMethodsByObjectPath 240 also reads and parses the configuration file 206 and searches for method definitions under a given object path. If a method matching the object path is found in the configuration file 206, the method 240 extracts and returns the name and parameters associated with the matching method from the configuration file 206. Alternatively, if no method corresponding to the object path is found a corresponding indication, e.g., “Method not found,” is returned.

The method ShowMethodsByMethodName 242 works similarly, but it searches for methods by both object path and method name. If a method matching the object path and method name is found, the method 242 extracts and returns the name and parameters associated with the matching method from the configuration file 206. Alternatively, if no method corresponding to the object path and method name is found, a corresponding indication, e.g., “Method not found,” is returned.

A D-Bus interface is initialized which is configured to handle D-Bus call requests of the methods 238, 240, and 242. Then, the interface xyz.openbmc_project.DbusMethodCaller 236 is registered with the D-Bus 208. In some embodiments, the interface is registered using a command bus.request_name( ) to ensure its uniqueness on the D-Bus 208.

The D-Bus system is configured to enters an event loop, continuously processing incoming D-Bus messages. The bus.process_discard( ) method discards all messages in the queue, while bus.wait( ) blocks the system, waiting for new messages to arrive and process.

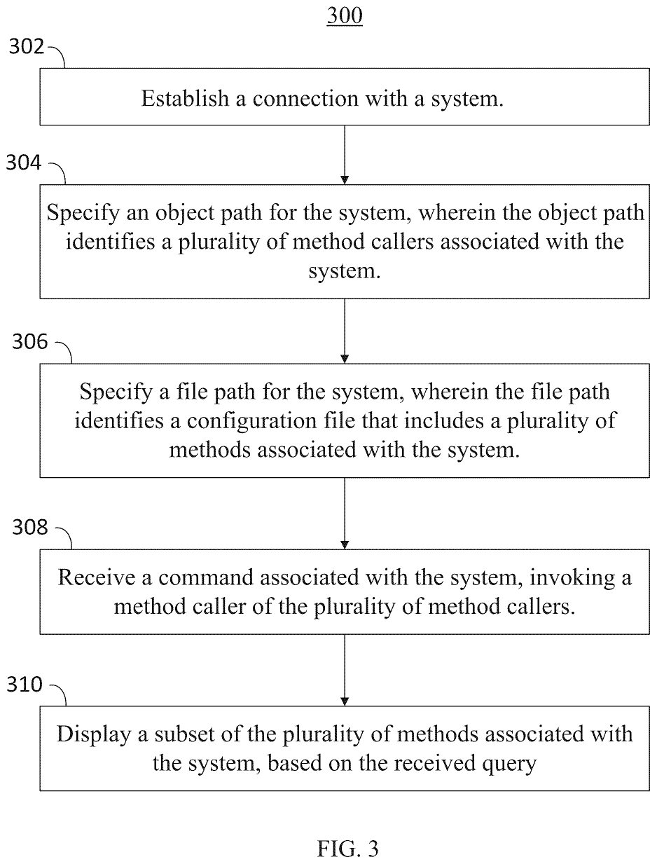

FIG. 3 illustrates a method 300 for dynamically querying methods, in accordance with one or more embodiments of the present disclosure. Method 300 may be performed by controller 110 as illustrated in FIG. 1, or other suitable control devices. Method 300 may be performed alone or in combination with other processes in the present disclosure. It will be recognized that method 300 may be performed in any suitable environment and in any suitable order except where otherwise apparent. Alternative steps may be performed instead of or in addition to those shown, and some steps may be omitted entirely.

At 302, a connection is established with a system bus.

At 304, an object path is specified for the system bus, wherein the object path identifies a plurality of method callers associated with the system bus. In some embodiments, the connection is established with the D-Bus 208 by defining a path to the interface. For example, the interface 236 is identified by the path xyz.openbmc_project.DbusMethodCaller specified with the interface. In some cases, such the interface 236 may be registered using a command bus.request_name( ) to ensure that the name of the interface is unique on the D-Bus 208.

At 306, a file path is specified for the system bus, wherein the file path identifies a configuration file that includes a plurality of methods associated with the system bus. As described previously, in order to access the configuration file 206, a path of the configuration file 206 is provided to the interface 236 so that the methods 238, 240, and 242 may access the configuration file 206.

At 308, a command associated with the system bus is received, wherein the command invokes a method caller of the plurality of method callers. Various methods may be defined in the interface 236. For example, the three methods may include a ShowAllMethods 238, a ShowMethodsByObjectPath 240, and a ShowMethodsByName 242. Any one of the three methods defined in the interface 236 may be invoked.

At 310, a subset of the plurality of methods associated with the system bus are displayed, based on the received query. Based on the function invoked in the interface 236, some or all of the methods of the configuration file 206 may be displayed. For example, the method ShowAllMethods 238 opens the configuration file 206, parses it into an object, and then traverses the object to extract interface names, method names, and parameters, returning this information in a formatted string. The method ShowMethodsByObjectPath 240 method also reads and parses the configuration file 206, then searches for method definitions under a given object path. The method ShowMethodsByMethodName 242 method works similarly, but it searches for methods by both object path and method name.

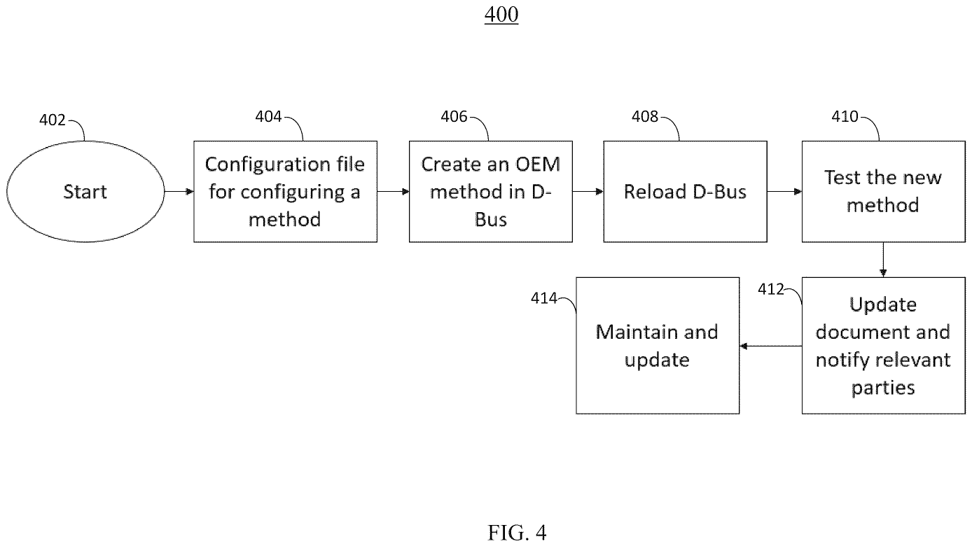

FIG. 4 illustrates a method 400 for dynamically querying a D-Bus, in accordance with one or more embodiments of the present disclosure. Method 400 may be performed by controller 110 as illustrated in FIG. 1, or other suitable control devices. Method 400 may be performed alone or in combination with other processes in the present disclosure. It will be recognized that method 400 may be performed in any suitable environment and in any suitable order except where otherwise apparent. Alternative steps may be performed instead of or in addition to those shown, and some steps may be omitted entirely.

At 402, the method for dynamically querying a D-Bus starts.

At 404, a configuration file may be edited or modified and add input parameter information of a new D-Bus method from an Original Equipment Manufacturer (OEM) to the configuration file. In some embodiments, the configuration file 206 may be a JSON file that is created and includes a list of methods associated with a plurality of interfaces that are meant to provide access to a plurality of objects connected to the D-Bus.

At 406, a new method from an Original Equipment Manufacturer (OEM) is created in the D-Bus service based on the information in the configuration file. For example, three methods ShowAllMethods 238, ShowMethodsByObjectPath 240, and ShowMethodsByName 242 may be defined in a new interface 236 identified by the path “xyz.openbmc.project.Dbusmethodcaller.” The different methods of the interface 236 may be configured to search for different methods in the configuration file 206 based on provided parameters.

At 408, the D-Bus service is reloaded for the new method to take effect.

At 410, test cases are written to verify that newly added methods work as expected. For example, test cases may be written to test the methods ShowAllMethods 238, ShowMethodsByObjectPath 240, and ShowMethodsByName 242. For ShowAllMethods 238, the test cases may be configured to determine whether the method opens the configuration file 206, parses it into an object, and then traverses the object to extract interface names, method names, and parameters, returning this information in a formatted string. For ShowMethodsByObjectPath 240, the test cases may be used to determine whether the method ShowMethodsByObjectPath 240 reads and parses the configuration file 206 and searches for method definitions under a given object path. For ShowMethodsByName 242, the test cases may be configured to determine whether the method ShowMethodsByName 242 searches for methods in the configuration file 206 based on both an object path and method name.

At 412, documentation is updated to reflect addition of new methods and notify relevant stakeholders, such as other developers or end users.

At 414, the configuration file is regularly updated and maintained to reflect changes and needs of the service.

It is noted that the techniques described herein may be embodied in executable instructions stored in a non-transitory computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. The elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method for querying methods, comprising:
establishing a connection with a system;
specifying an object path for the system, wherein the object path identifies a plurality of method callers stored in the system;
specifying a file path for the system, wherein the file path identifies a configuration file that includes a plurality of methods associated with the system, wherein each of the plurality of method callers is predefined to query the plurality of methods included in the configuration file according to a different predefined querying manner;
receiving a query associated with the system;
invoking, based on the query, a method caller of the plurality of method callers, wherein the method caller accesses the configuration file based on the file path, parses and traverses the plurality of methods included in the configuration file, and returns results in a formatted string; and
displaying a subset of the plurality of methods associated with the system, based on the received formatted string.

2. The method of claim 1, wherein the method further comprises:
extracting, using the method caller, each method of the plurality of methods associated with an interface from the configuration file; and
providing each method of the plurality of methods associated with the system for displaying.

3. The method of claim 1, wherein the invocation of the method caller includes a file path parameter, and wherein the method further comprises:
extracting, using the method caller, each method of the plurality of methods associated with the file path parameter from the configuration file; and
providing the extracted methods associated with the system for displaying.

4. The method of claim 3, wherein each method of the extracted methods is located at a file path identified by the file path parameter.

5. The method of claim 1, wherein the invocation of the method caller includes a file name parameter, and wherein the method is further configured to:
extracting, using the method caller, each method of the plurality of methods associated with the file name parameter from the configuration file; and
providing the extracted methods associated with the system for displaying.

6. The method of claim 5, wherein each method of the extracted methods has a same name as a name identified by the file name parameter.

7. The method of claim 1, wherein the configuration file is a Javascript Object Notation (JSON) file.

8. A system for querying methods, the system comprising:
a controller configured to:
establish a connection with the system;
specify an object path for the system, wherein the object path identifies a plurality of method callers stored in the system;
specify a file path for the system, wherein the file path identifies a configuration file that includes a plurality of methods associated with the system, wherein each of the plurality of method callers is predefined to query the plurality of methods included in the configuration file according to a different predefined querying manner;
receive a query associated with the system;
invoke, based on the query, a method caller of the plurality of method callers, wherein the method caller accesses the configuration file based on the file path, parses and traverses the plurality of methods included in the configuration file, and returns results in a formatted string; and
display a subset of the plurality of methods associated with the system, based on the received formatted string.

9. The system of claim 8, wherein the controller configured to receive the query associated with the system, invoking the method caller, is further configured to:
extract, using the method caller, each method of the plurality of methods associated with an interface from the configuration file; and
provide each method of the plurality of methods associated with the system for displaying.

10. The system of claim 8, wherein the invocation of the method caller includes a file path parameter, and wherein the controller configured to receive the query associated with the system, invoking the method caller, is further configured to:
extract, using the method caller, each method of the plurality of methods associated with the file path parameter from the configuration file; and
provide the extracted methods associated with the system for displaying.

11. The system of claim 10, wherein each method of the extracted methods is located at a file path identified by the file path parameter.

12. The system of claim 8, wherein the invocation of the method caller includes a file name parameter, and wherein the controller configured to receive the query associated with the system, invoking the method caller, is further configured to:
extract, using the method caller, each method of the plurality of methods associated with the file name parameter from the configuration file; and
provide the extracted methods associated with the system for displaying.

13. The system of claim 12, wherein each method of the extracted methods has a same name as a name identified by the file name parameter.

14. The system of claim 8, wherein the configuration file is a Javascript Object Notation (JSON) file.

15. A tangible, non-transitory computer-readable medium for querying methods, the computer-readable medium having instructions thereon, which, upon being executed by one or more processors, provides for execution of the following steps:
establishing a connection with a system;
specifying an object path for the system, wherein the object path identifies a plurality of method callers stored in the system;
specifying a file path for the system, wherein the file path identifies a configuration file that includes a plurality of methods associated with the system, wherein each of the plurality of method callers is predefined to query the plurality of methods included in the configuration file according to a different predefined querying manner;
receiving a query associated with the system;
invoking, based on the query, a method caller of the plurality of method callers, wherein the method caller accesses the configuration file based on the file path, parses and traverses the plurality of methods included in the configuration file, and returns results in a formatted string; and
displaying a subset of the plurality of methods associated with the system, based on the received formatted string.

16. The non-transitory computer readable medium of claim 15, wherein the instructions further comprise:
extracting, using the method caller, each method of the plurality of methods associated with an interface from the configuration file; and
providing each method of the plurality of methods associated with the system for displaying.

17. The non-transitory computer readable medium of claim 15, wherein the invocation of the method caller includes a file path parameter, and wherein the instructions further comprise:
extracting, using the method caller, each method of the plurality of methods associated with the file path parameter from the configuration file; and
providing the extracted methods associated with the system for displaying.

18. The non-transitory computer readable medium of claim 17, wherein each method of the extracted methods is located at a file path identified by the file path parameter.

19. The non-transitory computer readable medium of claim 15, wherein the invocation of the method caller includes a file name parameter, and wherein the instructions further comprise:
extracting, using the method caller, each method of the plurality of methods associated with the file name parameter from the configuration file; and
providing the extracted methods associated with the system for displaying.

20. The non-transitory computer readable medium of claim 19, wherein each method of the extracted methods has a same name as a name identified by the file name parameter.
